(19) United States
(12) Patent Application Publication
(10) Pub. No.: US 2007/0084295 A1
(43) Pub. Date: Apr. 19, 2007

(54) Displacement-measuring apparatus and power-measuring apparatus

(75) Inventors: Tatsuya Hattori, Saitama-ken (JP); Pu Qian, Saitama-ken (JP)

Correspondence Address: LAHIVE & COCKFIELD, LLP, ONE POST OFFICE SQUARE, BOSTON, MA, 02109-2127, US

(73) Assignee: Honda Moror Co., Ltd., Tokyo (JP)

(21) Appl. No.: 10/578,399

(22) PCT Filed: Nov. 1, 2004
(86) PCT No.: PCT/JP04/16211

§ 371 Date: May 4, 2006

(30) Foreign Application Priority Data
Nov. 5, 2003 (JP) 2003-375539

(51) Int. Cl. G01N 3/00

(52) U.S. Cl. 73/794

(57) ABSTRACT

A displacement amount measuring apparatus for measuring the amount of the displacement of a movable member (3) with a displacement sensor (81) by extending and/or retracting a specimen (S) by an operating means (100) to displace the movable member (3) and a generated force measuring device for measuring, with a load cell, a force generated when the specimen (S) is extended/retracted. The displacement amount measuring device for measuring the extended amount and/or the retracted amount of the specimen (S) by extending and/or retracting the specimen (S) comprises the operating means (100) extending/retracting the specimen (S), the movable member (3) connected to the tip of the specimen (S), a friction reducing body (5) horizontally and movably supporting the movable member (3), and the displacement sensor (81) measuring the amount of the displacement of the movable member (3).

### FIELD OF THE INVENTION

The present invention relates to an apparatus for measuring the extension and/or contraction of a sample as displacement, and an apparatus for measuring power generated as a pushing force and/or a pulling force by the extension and/or contraction of a sample.

### BACKGROUND OF THE INVENTION

In the fields using electromagnetic motors such as robots, cutting machines, automobiles, etc., demand has been mounting to reduce the weight of driving systems. However, because the power densities of the electromagnetic motors depend on the weight of motors, the weight reduction of actuators utilizing the electromagnetic motors is limited. To obtain large power with reduced size and weight, actuators without using electromagnetic motors are desired. For example, as actuators which can be made smaller in size and weight, polymer actuators have recently been attracting much attention.

A polymer membrane actuator utilizes displacements caused by the extension and/or contraction of a polymer membrane, such as a polypyrrole membrane, by the supply of electric current. To put the polymer membrane actuators into practical use, their performance should be evaluated objectively. For this evaluation, it is indispensable to measure exact displacement and power generated by the polymer membrane, a driving body. Apparatuses for measuring the displacement and power of polymer membranes have thus been proposed.

M. R. Gandhi, P. Murray, G. M. Spinks, and G. G. Wallace describe in “Mechanism of Electromechanical Actuation in Polypyrrole,” Synthetic Metals 73(1995), 247-256, an electrochemical test cell attached to a loading point of an Instron 4302 tensile-testing machine (available from Instron). Using this electrochemical test cell, the displacement and power of a polypyrrole membrane test piece can be measured as follows. A top end of the test piece is electrically connected to a potentiostat so that the test piece acts as an electric connection. As a result, the test piece functions as a work electrode. A counter electrode constituted by a stainless steel net surrounds the test piece, and an Ag/AgCl reference electrode is disposed. The cell is filled with a test solution such as a 1-N NaNO₃ solution.

In this electrochemical test cell, voltage is applied to the test piece while pulling an upper portion of the test piece at rate of 1 mm/minute, to measure the decreased tension and extension of the test piece caused by the application of voltage. However, the amount of extension of the test piece caused by electric current cannot directly be measured, because the test piece is kept tensed. In addition, it is difficult to precisely measure the displacement and power of the test piece. Further, because the test piece is vertically set in the cell, the observation of the test piece is difficult during measurement, and the exchange of test pieces is troublesome.

### OBJECTS OF THE INVENTION

Accordingly, an object of the present invention is to provide a displacement-measuring apparatus and a power-measuring apparatus, which can precisely measure the displacement and/or power of an extending and contracting sample, without difficulty in observing the sample during measurement and exchanging them.

### DISCLOSURE OF THE INVENTION

As a result of intense research in view of the above object, the inventors have found that in an apparatus for measuring the displacement or power of an extending and/or contracting sample, by fixing a movable member to a front end of the sample, and activating the sample in a state where the movable member is horizontally and movably supported by a reduced-friction bearing, the displacement or power of the sample can be precisely measured without difficulty in exchanging the samples. The present invention has been completed based on such finding.

Thus, the apparatus of the present invention for measuring the extension and/or contraction of a sample as displacement comprises a working means for extending or contracting the sample, a movable member connected to a front end of the sample, a reduced-friction bearing for supporting the movable member horizontally and movably, and a displacement sensor for detecting the displacement of the movable member, whereby the sample is extended and/or contracted by the working means to cause the displacement of the movable member, which is detected by the displacement sensor.

It is preferable that the displacement is measured by extending and/or contracting the sample while applying a load to the movable member in an opposite direction to the displacing direction of the movable member.

One preferable example of the displacement-measuring apparatus further comprises a cell containing the sample, a pulley provided on the rear side of a front end of the movable member, and a weight suspending from the pulley with a string, the rear end of the sample being fixed in the cell, the string being horizontally supported by the movable member and the pulley so that a load is applied from the weight to the sample when extending, and the working means acting to extend the sample, thereby displacing the movable member forward so that the extension of the sample is measured.

Another preferable example of the displacement-measuring. apparatus further comprises a cell containing the sample, a pulley provided on the front side of a rear end of the movable member, and a weight suspending from the pulley with a string, the rear end of the sample being fixed in the cell, the string being horizontally supported by the movable member and the pulley so that a load is applied from the weight to the sample when contracting, and the working means acting to contract the sample, thereby displacing the movable member rearward so that the contraction of the sample is measured.

It is preferable that the displacement-measuring apparatus comprises a cell-fixing member comprising a rod perpendicularly fixed to the rear end of the cell and a stand horizontally supporting the fixing rod, and that the sample is fixed to an inner surface of the cell. The displacement-measuring apparatus may comprise a sample-fixing member comprising a fixing rod, a stand supporting the fixing rod, and a fixing plate perpendicularly fixed to the front end of the fixing rod, the fixing rod being horizontally supported by the stand, and the sample being fixed to the fixing plate.

The apparatus for measuring the displacement of a sample extending and/or contracting by the supply of electric current preferably comprises a work electrode connected to the rear end of the sample, an electrolytic solution contained in the cell, and a counter electrode soaked in the electrolytic solution, the work electrode being fixed in the cell, and the sample being soaked in the electrolytic solution, whereby the sample extends and/or contracts by the supply of electric current between the work electrode and the counter electrode.

A further example of the displacement-measuring apparatus comprises a sample-fixing rod, a stand horizontally supporting the fixing rod, a pulley provided on the rear side of a front end of the movable member, and a weight suspending from the pulley with a string, the string being horizontally supported by the movable member and the pulley so that a load is applied from the weight to the sample when extending, and the working means acting to extend the sample, thereby displacing the movable member forward so that the extension of the sample is measured.

A still further example displacement-measuring apparatus, comprises a sample-fixing rod, a stand horizontally supporting the fixing rod, a pulley provided on the front side of a rear end of the movable member, and a weight suspending from the pulley with a string, the string being horizontally supported by the movable member and the pulley so that a load is applied from the weight to the sample when contracting, and the working means acting to contract the sample, thereby displacing the movable member rearward so that the contraction of the sample is measured.

The apparatus comprising a solid electrolyte for measuring the displacement of a sample extending and/or contracting by the supply of electric current comprises a work electrode connected to the rear end of the sample, and a counter electrode connected to a front end of the sample, the rear end of the sample being fixed to the rod via the work electrode, and the front end of the sample being fixed to the movable member via the counter electrode, whereby the sample extends and/or contracts by the supply of electric current between the work electrode and the counter electrode.

In any displacement-measuring apparatus, the reduced-friction bearing is preferably an air bearing. It is preferable that the displacement-measuring apparatus comprises a stage vertically supporting the stand on the rear side of the sample, the stage being movable in the displacing direction of the movable member and/or in its opposite direction when receiving a signal from the displacement sensor.

The apparatus of the present invention for measuring power generated as a pushing force and/or a pulling force by a sample comprises a means for activating the sample, a movable member connected to a front end of the sample, a load cell attached to a front end of the movable member, and a reduced-friction bearing horizontally and movably supporting the movable member, the power generated by the sample by the action of a working means being transmitted to the load cell via the movable member and measured thereby.

It is preferable that the pushing force and/or pulling force of the sample are measured with a load applied to the sample in the same or opposite direction to the moving direction of the movable member.

One preferable example of the power-measuring apparatus comprises a pulley provided on the rear side of a front end of the movable member, and a weight suspending from the pulley with a string, the string being horizontally supported by the movable member and the pulley so that a load is applied from the weight to the movable member when the pushing force is generated.

Another example of the power-measuring apparatus comprises a pulley provided on the front side of a rear end of the movable member, and a weight suspending from the pulley with a string, the string being horizontally supported by the movable member and the pulley so that a load is applied from the weight to the movable member when the pulling force is generated.

The apparatus for measuring a power generated as a pushing force and/or a pulling force by a sample by the supply of electric current preferably comprises a cell containing the sample, a work electrode connected to a rear end of the sample, an electrolytic solution contained in the cell, and a counter electrode soaked in the electrolytic solution, whereby the power is generated by the supply of electric current between the work electrode and the counter electrode.

A further example of the power-measuring apparatus further comprises a sample-fixing rod attached to a rear end of the sample, a stand horizontally supporting the fixing rod, a pulley provided on the rear side of a front end of the movable member, and a weight suspending from the pulley with a string, the string being horizontally supported by the movable member and the pulley so that a load is applied from the weight to the sample when the pushing force of the sample is generated.

A still further example of the power-measuring apparatus further comprises a sample-fixing rod attached to a rear end of the sample, a stand horizontally supporting the fixing rod, a pulley provided on the front side of a rear end of the movable member, and a weight suspending from the pulley with a string, the string being horizontally supported by the movable member and the pulley so that a load is applied from the weight to the sample when the pulling force of the sample is generated.

The apparatus comprising a solid electrolyte for measuring a power generated as a pushing force and/or a pulling force by a sample by the supply of electric current comprises a work electrode connected to the rear end of the sample, and a counter electrode connected to a front end of the sample, whereby the power is generated by the supply of electric current between the work electrode and the counter electrode.

In any power-measuring apparatus, the reduced-friction bearing is preferably an air bearing. The displacement-measuring apparatus preferably comprises a stage vertically supporting the stand on the rear side of the sample, the stage being movable in the displacing direction of the movable member and/or in its opposite direction when receiving a signal from the load cell.

### BRIEF DESCRIPTION OF THE DRAWINGS

FIG. 1 is a schematic view showing one example of the displacement-measuring apparatus of the present invention.

FIG. 2 is a schematic view showing one example of the power-measuring apparatus of the present invention.

FIG. 3 is a schematic view showing another example of the displacement-measuring apparatus of the present invention.

FIG. 4 is a schematic view showing the assembly and operation of the displacement-measuring apparatus, (a) showing the order of setting a sample, etc. in the cell, (b) showing a state in which no electric current is supplied between the electrodes, and (c) showing a state in which the sample is extended by the supply of electric current.

FIG. 5 is a schematic view showing another example of the power-measuring apparatus of the present invention.

FIG. 6 is a schematic view showing a further example of the displacement-measuring apparatus of the present invention.

FIG. 7 is a schematic view showing a still further example of the power-measuring apparatus of the present invention.

FIG. 8 is a schematic view showing a still further example of the displacement-measuring apparatus of the present invention.

FIG. 9 is a schematic view showing a still further example of power-measuring apparatus of the present invention.

FIG. 10 is a graph showing the displacements and frictions measured by the apparatuses of example 1 and Comparative Example 1.

### DESCRIPTION OF THE PREFERRED EMBODIMENTS

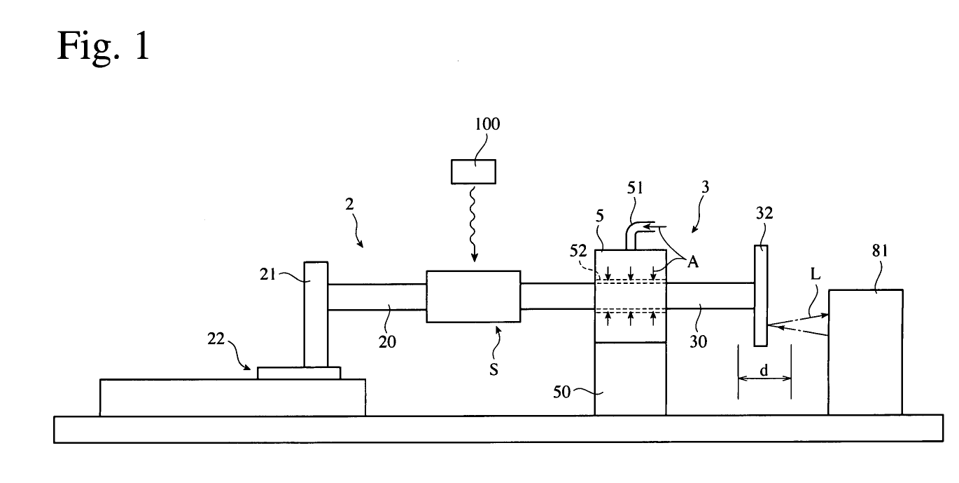

FIG. 1 shows one example of the displacement-measuring apparatus of the present invention. This displacement-measuring apparatus comprises a member 2 for supporting a sample S, a movable member 3 connected to a front end of the sample S, an air bearing 5 supporting the movable member 3, a laser displacement sensor 81 provided on the front side of the movable member 3. The sample S extends and/or contracts by the action of a working means 100. It is described herein that the movable member 3 moves toward “the front side” when the sample S extends and toward “the rear side” when the sample S contracts.

The sample-fixing member 2 comprises a fixing rod 20 and a stand 21 supporting the fixing rod 20. The front end of the fixing rod 20 is fixed to the rear end of the sample S. The rear end of the fixing rod 20 is fixed perpendicularly to the stand 21, so that the fixing rod 20 extends horizontally. The stand 21 is vertically supported by a stage 22. The stage 22 receives the data of displacement detected by a laser displacement sensor 81. The stage 22 is movable back and forth by a distance corresponding to the displacement of the movable member 3 in the displacing direction.

The movable member 3 comprises a horizontally supported movable rod 30, and a reflection plate 32 fixed perpendicularly to a front end of the movable rod 30. A rear end of the movable member 3 is fixed to the sample S, with its front end free. Because the movable rod 30 is movably supported by an air bearing 5, it moves according to the extension and/or contraction of the sample S. The amount of displacement of the movable member 3 is equal to the amount of the extension or contraction of the sample S, and the moving direction of the movable member 3 is the same as the extending or contracting direction of the sample S.

The reflection plate 32 is perpendicularly fixed to a front end of the movable rod 30. The reflection plate 32 stays in a range d detectable by the laser displacement sensor 81. Accordingly, the amount of displacement of the reflection plate 32 can be measured by applying a laser beam to the reflection plate 32.

The air bearing 5 is fixed to a support 50 such that the movable rod 30 extends horizontally. The air bearing 5 has a pipe 51 for supplying air A. A gap 52 between the air bearing 5 and the movable rod 30 is filled with the air A supplied from the pipe 51, so that the air bearing 5 supports the movable rod 30 with substantially no contact. Thus, the coefficient of kinetic friction of the movable rod 30 is almost zero.

The method of extending and/or contracting the sample S by the action of a working means 100 is not particularly limited but may be suitably selected depending on the sample. Examples of the method of extending and/or contracting the sample S include a method of supplying electric current to the sample S, a method of irradiating sound, light, or electromagnetic waves to the sample S, a method of changing the temperature of the sample S, a method of changing the pH or concentration of a solution in which the sample S is soaked, etc.

When the sample S extends by the action of the working means 100, the movable rod 30 moves rightward in FIG. 1 (toward the laser displacement sensor 81). Because the reflection plate 32 fixed to the front end of the movable rod 30 moves by the same distance, the displacement of the movable member 3 corresponding to the extension or contraction of the sample S can be measured by applying laser beams L from the laser displacement sensor 81 to the reflection plate 32 (a) during the extension and/or contraction of the sample S, or (b) before and after the extension and/or contraction. On the other hand, when the sample S contracts, the movable rod 30 moves leftward in FIG. 1. The amount of contraction can be measured by the laser displacement sensor 81 in the same manner as the extension.

The information of the displacement may be sent to the stage 22, so that it moves toward or away from the laser displacement sensor 81 by a desired distance depending on the amount of displacement. The moving distance of the stage 22 is preferably programmed, such that the stage 22 moves toward or away from the laser displacement sensor 81 by a distance corresponding to the displacement. The stage 22 effectively moves, when the extension of the sample S is too large to keep the reflection plate 32 within the detectable range d of the laser displacement sensor 81. Specifically, the stage 22 is caused to move away from the laser displacement sensor 81 to move the fixing rod 20 and thus the sample S and the reflection plate 32 rearward, so that the reflection plate 32 can return within the detectable range d.

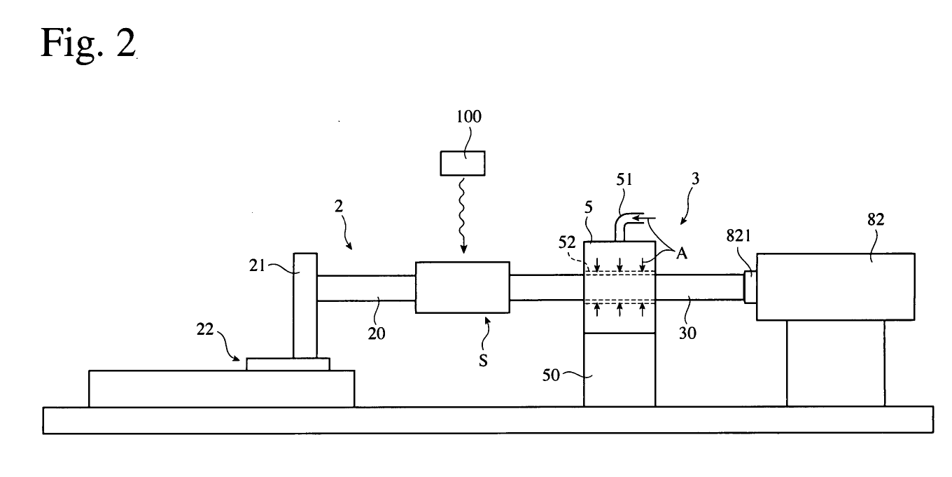

FIG. 2 shows one example of the power-measuring apparatus. This power-measuring apparatus is substantially the same as the displacement-measuring apparatus shown in FIG. 1, except that the front end of the movable member 3 is connected to the load cell 82. Accordingly, only differences will be explained below.

The front end of the movable rod 30 is fixed to a load button 821 of the load cell 82. The load button 821 is in contact with a strain sensor (not shown) in the load cell 82. When the load button 821 is pushed by the movable rod 30, the strain sensor is deformed to detect a load.

Because the sample S has a fixed rear end and a front end connected to the movable rod 30, which is connected to the load cell 82, there is no room for the sample S to extend on both sides. Thus, when the working means 100 causes the sample S to generate an extending and/or contracting force, the output power of the sample S is transmitted to the load cell 82 via the movable rod 30 without substantial extension or contraction, enabling the measurement of the output power of the sample S when it extends and/or contracts.

The stage 22 may apply the fixing rod 20 a force toward or away from the load cell 82. Such function of the stage 22 makes it possible to measure the power of the sample S with a changing load applied to the sample S. In this case, the output power of the sample S is the sum of the force measured by the load cell 82 and the force supplied by the stage 22. Needless to say, the stage 22 may be used to finely adjust the fixing rod 20 so that the movable rod 30 abuts the load cell 82.

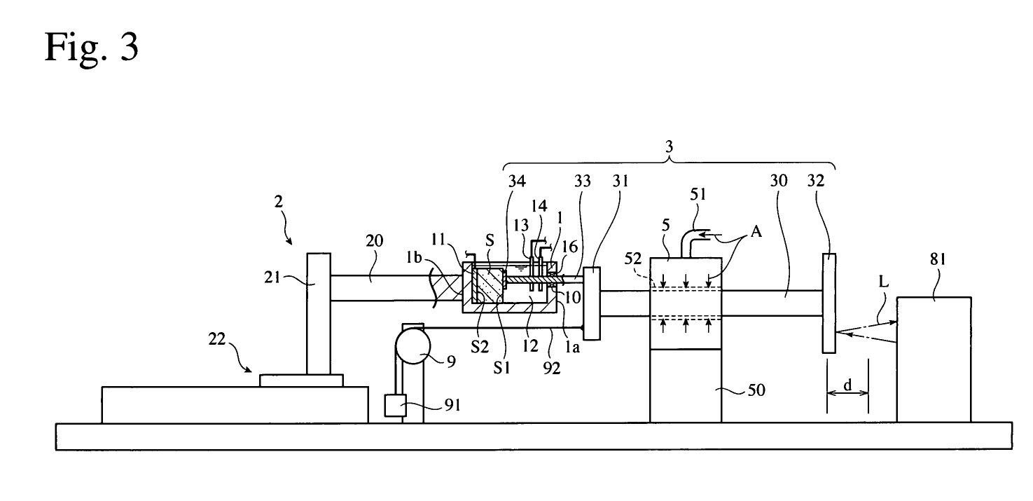

FIG. 3 shows another example of the displacement-measuring apparatus. This displacement-measuring apparatus is substantially the same as shown in FIG. 1 except for comprising a box-shaped cell 1 and a weight 91 for applying a load to a movable member 3. Accordingly, only differences will be explained below. This displacement-measuring apparatus comprises a box-shaped cell 1, a fixing rod 20 fixed to the rear end 1b of the cell 1, a movable member 3 fixed to the front side 1a of the cell 1, an air bearing 5 supporting the movable member 3, and a laser displacement sensor 81 placed on the front side of the movable member 3. A pulley 9 is disposed near the cell 1, and the weight 91 suspends from the pulley 9. The weight 91 is linked by a string 92 to the movable member 3.

The sample S is contained in the cell 1 with its fixed rear end S2 attached to a work electrode 11. The cell 1 is filled with an electrolytic solution 12, in which a counter electrode 13 and a reference electrode 14 are soaked. The work electrode 11, the counter electrode 13, and a reference electrode 14 are connected to respective lead wires. The front end S1 of the sample S is attached to the rear end of the movable member 3. Because a lower half of the front end S1 of the sample S is not covered with a movable plate 34, the sample S is in sufficient contact with the electrolytic solution 12. Thus, voltage applied between the work electrode 11 and the counter electrode 13 causes sufficient electric current to flow through the sample S, achieving contraction or extension.

The movable member 3 comprises a horizontal, movable rod 30 supported by an air bearing 5, a load-applying plate 31 perpendicularly fixed to a rear end of the movable rod 30, a reflection plate 32 perpendicularly fixed to a front end of the movable rod 30, and a movable bar 33 perpendicularly fixed to the load-applying plate 31. A rear end of the movable bar 33 is perpendicularly fixed to the movable plate 34. The movable bar 33 penetrates through an opening 10 of a front wall 1 a of the cell 1 and is movably supported by a bearing 16 provided in the opening 10. A gap between the movable bar 33 and the opening 10 is sealed to prevent the leak of the electrolytic solution 12.

Because a vertical load-applying plate 31 is perpendicularly fixed to the movable bar 33 and the movable rod 30, the load-applying plate 31 moves according to the displacement of the movable bar 33 and the movable rod 30. The string 92 suspending the weight 91 is fixed to a rear face of the load-applying plate 31 (on the side of the movable bar 33). The string 92 is horizontally supported by the load-applying plate 31 and the pulley 9. Thus, when the sample S extends, it receives a load from the weight 91 suspending from the pulley 9. Materials for the string 92 are not limited as long as the string 92 can support the weight 91. The materials of the string 92 may be, for instance, natural fibers such as cotton, or synthetic fibers such as nylon. The string 92 may also be a metal wire.

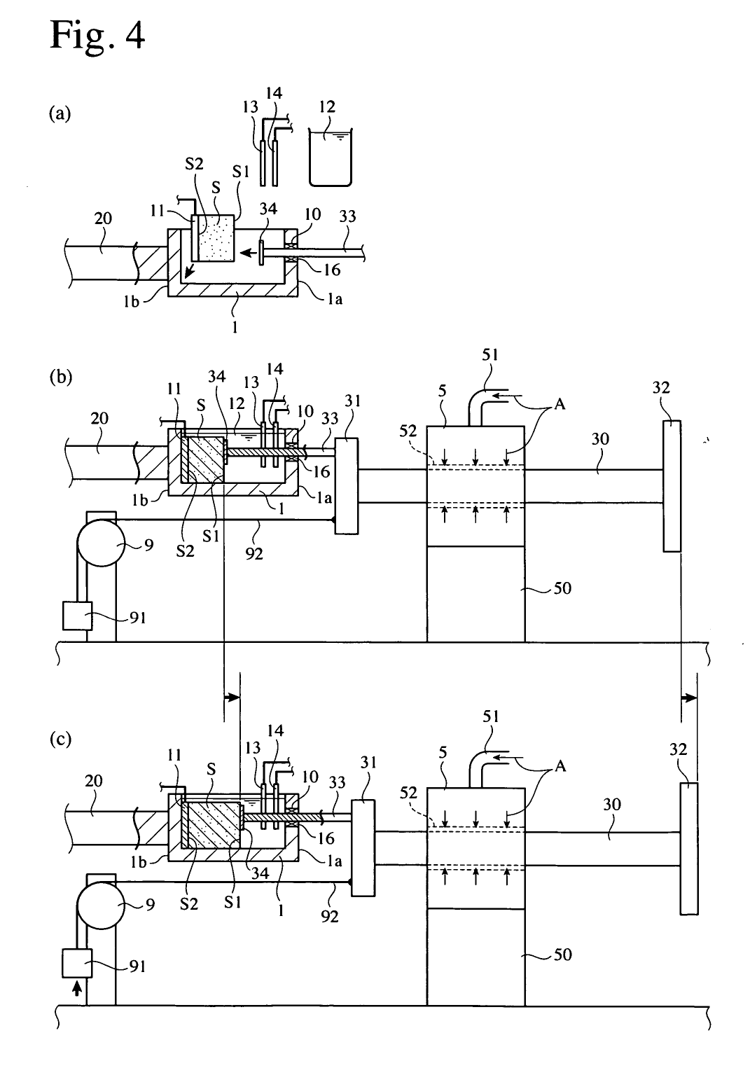

As shown in FIG. 4(a), the sample S having the work electrode 11 attached to its one end is contained in the cell 1 with the work electrode 11 directed toward the fixing rod 20, and the work electrode 11 is fixed to the inner face of the cell 1. Thus, the rear end S2 of the sample S on the side of the work electrode 11 serves as a fixed end. The front end S1 is fixed to the movable plate 34. The movable bar 33 is preferably fixed to the movable plate 34 beforehand. The cell 1 is then filled with the electrolytic solution 12, in which the counter electrode 13 and the reference electrode 14 are soaked. The order of arranging them in the cell 1 is not particularly limited, and for instance, the electrolytic solution 12 may be charged into the cell 1 after the counter electrode 13, etc. are disposed therein.

With the weight 91 suspending from the pulley as shown in FIG. 4(b), voltage is applied such that the work electrode 11 acts as an anode or a cathode. When sufficient voltage is applied, the sample S receiving electric current extends against the load of the weight 91 [FIG. 4(c)]. When the sample S extends, the movable bar 33 and the movable rod 30 moves rightward in FIG. 4 (toward the displacement sensor 81). The reflection plate 32 fixed to the front end of the movable rod 30 moves by the same distance, enabling the measurement of the extension of the sample S by the laser displacement sensor 81. Which direction of electric current should be supplied to the work electrode 11 serving as an anode or a cathode to extend the sample S depends on the compositions of the sample S and/or the electrolytic solution 12.

What is needed to measure the contraction of the sample S is only to place the pulley 9 on the front side of the load-applying plate 31 (on the side of the laser displacement sensor 81), so that a load is applied from the weight 91 when the sample S contracts, and to supply electric current of an opposite polarity to the sample S. If the pulley 9 is placed on the front side of the laser displacement sensor 81 (right side in FIG. 4), the string 92 may be connected to the reflection plate 32. When sufficient voltage is applied, the sample S receiving electric current contracts against a load from the weight 91, so that the movable bar 33 and the movable rod 30 move leftward in FIG. 4 (toward the fixing rod 20). Thus, the reflection plate 32 fixed to the front end of the movable rod 30 also moves by the same distance, enabling the measurement of the contraction of the sample S by the laser displacement sensor 81.

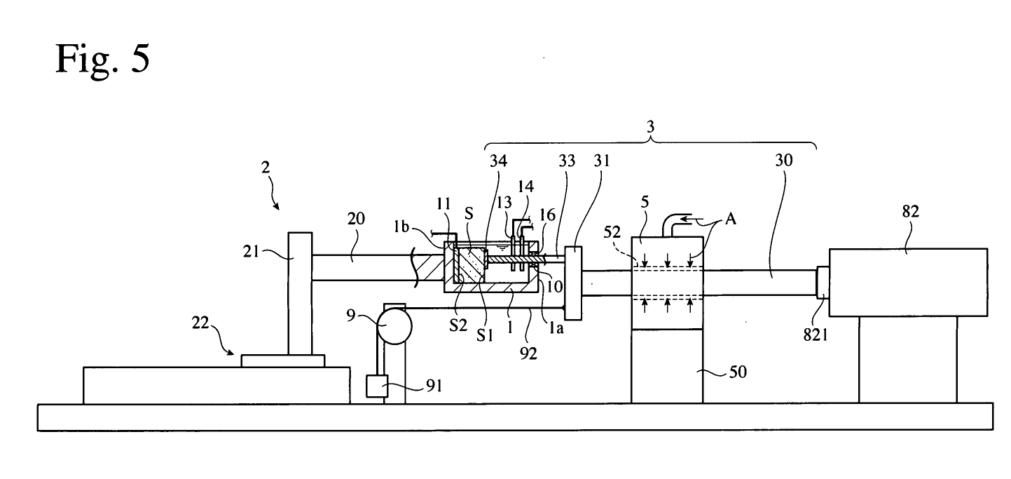

FIG. 5 shows another example of the power-measuring apparatus. This power-measuring apparatus is substantially the same as the displacement-measuring apparatus shown in FIGS. 3 and 4, except that the front end of a movable member 3 is connected to the load cell 82. Accordingly, only differences will be explained below.

The movable member 3 comprises a movable rod 30 horizontally supported by an air bearing 5, a load-applying plate 31 perpendicularly fixed to a rear end of the movable rod 30, and a movable bar 33 perpendicularly fixed to the load-applying plate 31. A front end of the movable rod 30 is fixed to a load button 821, which is in contact with a strain sensor (not shown) in the load cell 82. When the load button 821 is pushed by the movable rod 30, the strain sensor is deformed to detect the load.

With the weight 91 suspending from the pulley 9, voltage is applied such that the work electrode 11 acts as an anode or a cathode. Although an extending force is generated by the sample S receiving electric current, there is no room for the sample S to extend on both sides, because the rear end of the sample S is fixed, and because the front end of the movable rod 30, which is connected to the front end S1, is fixed to the load cell 82. Thus, the output power of the sample S is transmitted to the load cell 82 via the movable rod 30 without substantial extension, enabling the measurement of the output power of the sample S.

What is needed to measure the contracting power of the sample S is only to place the pulley 9 on the front side of the load-applying plate 31 (on the side of the laser displacement sensor 81) so that a load of the weight 91 is applied when the sample S contracts, and to supply electric current of an opposite polarity to the sample S. The contracting power generated by the sample S by receiving electric current is transmitted to the load cell 82 via the movable bar 33 and the movable rod 30, enabling the measurement of the contracting power of the sample S.

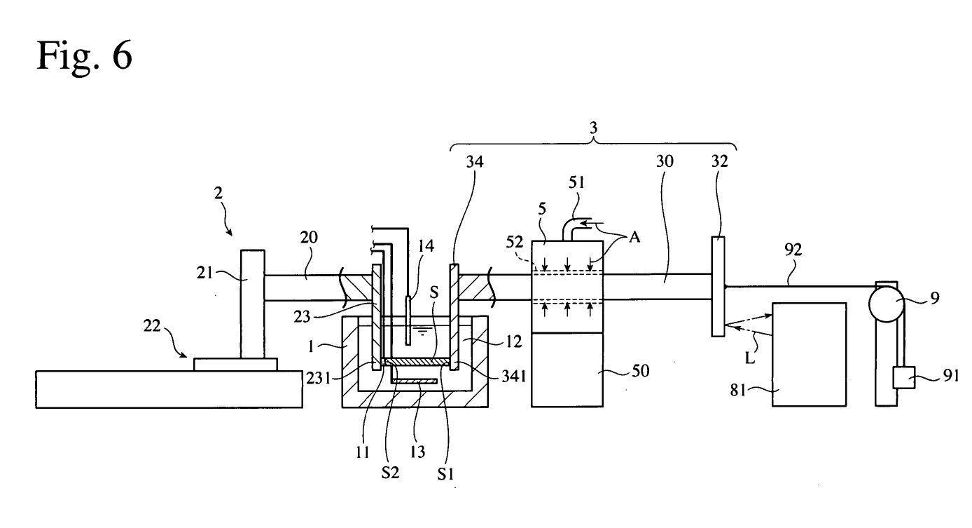

The displacement-measuring apparatus shown in FIG. 6 is substantially the same as shown in FIGS. 3 and 4, except that the weight 91 is fixed to the movable member 3 to pull the sample S. Accordingly, only differences will be explained below. This displacement-measuring apparatus is usable to measure the contraction of a membrane sample S.

A rear end S2 of the sample S is fixed to a lower end portion 231 of a sample-fixing plate 23, which is perpendicularly fixed to the front end of the fixing rod 20, A work electrode 11 is formed in the lower end portion 231 of the sample-fixing plate 23, and the lower end portion 231 is soaked in the electrolytic solution 12. The sample S has a rear end S2 bonded to the work electrode 11, and a front end S1 fixed to a lower end portion 341 of a movable plate 34. Thus, the sample S is soaked in the electrolytic solution 12 in the longitudinal direction of the cell 1.

The movable member 3 comprises a movable rod 30, a movable plate 34 perpendicularly fixed to the movable rod 30, and a reflection plate 32 perpendicularly fixed the front end of the movable rod 30. The movable plate 34 is perpendicularly fixed to the rear end of the movable rod 30, and the movable plate 34 and the movable rod 30 move leftward in the figure (toward the fixing rod 20) when the sample S contracts.

The cell 1 contains the electrolytic solution 12, in which a counter electrode 13 and a reference electrode 14 are soaked. The counter electrode 13 is preferably in the form of a plate or a mesh, and soaked in the electrolytic solution 12 in parallel to the sample S.

A pulley 9 suspending a weight 91 is placed on the front side of a laser displacement sensor 81. A rear end of a string 92 connected to the weight 91 is fixed to the reflection plate 32.

With the weight 91 suspending from the pulley 9 as shown in FIG. 6, voltage is applied such that the work electrode 11 acts as an anode or a cathode. When sufficient voltage is applied, the sample S contracts against a load of the weight 91, so that the movable rod 30 moves leftward in the figure. The reflection plate 32 fixed to the front end of the movable rod 30 also moves by the same distance, enabling the measurement of the displacement by the laser displacement sensor 81.

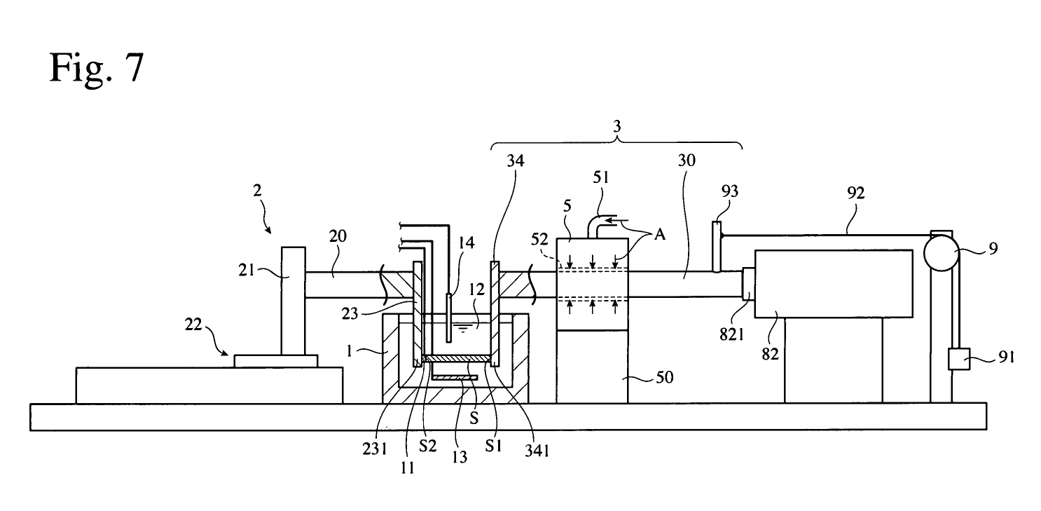

The power-measuring apparatus shown in FIG. 7 is substantially the same as shown in FIG. 5, except that the movable plate 34 is fixed to the movable rod 30, and that the weight 91 is fixed to the movable member 3 such that it pulls the sample S. Accordingly, only differences will be explained below. This power-measuring apparatus is used to measure a pulling force generated when a membrane sample contracts.

The rear end S2 of the sample S is fixed to a lower end portion 231 of a fixing plate 23. The fixing plate 23 is perpendicularly fixed to the front end of a fixing rod 20. The lower end portion 231 of the fixing plate 23 is provided with a work electrode 11, to which the rear end S2 of the sample S is bonded. The front end S1 is fixed to a lower end portion 341 of a movable plate 34, which is perpendicularly fixed to the movable rod 30. The movable rod 30 and the movable plate 34 move together when the sample S contracts.

The cell 1 contains an electrolytic solution 12, in which a counter electrode 13 and a reference electrode 14 are soaked. The counter electrode 13 is preferably in the form of a plate or a mesh, and immersed in the longitudinal direction of the cell 1 so that it is in parallel to the sample S.

The front end of the movable rod 30 is fixed to the load button 821 of the load cell 82, such that the power of the sample S is transmitted to the load button 821 via the movable rod 30. A pulley 9 suspending a weight 91 is placed on the front side of the load cell 82. A support member 93 is perpendicularly attached to the movable rod 30 near its front end, and a rear end of the string 92 is fixed to the support member 93. The string 92 is horizontally supported by the pulley 9 and the supporting member 93. Although the supporting member 93 is a rod in the example shown in FIG. 7, it may be a plate. Also, the string 92 may be fixed to the movable plate 34. When the string 92 is fixed to the movable plate 34, the movable plate 34 should be made larger to prevent the string 92 from touching the support 50.

Because the weight 91 is attached such that it pulls the sample S and the movable rod 30 forward (rightward in FIG. 7), the movable rod 30 pushes the load button 821 when no electric current is supplied to the sample S. When voltage is applied such that the work electrode 11 acts as an anode or a cathode, a contracting force is generated by the sample S, so that the movable rod 30 is pulled toward the sample S. As a result, a load applied to the load button 821 decreases. This decreased amount of load corresponds to the contracting power generated by the sample S.

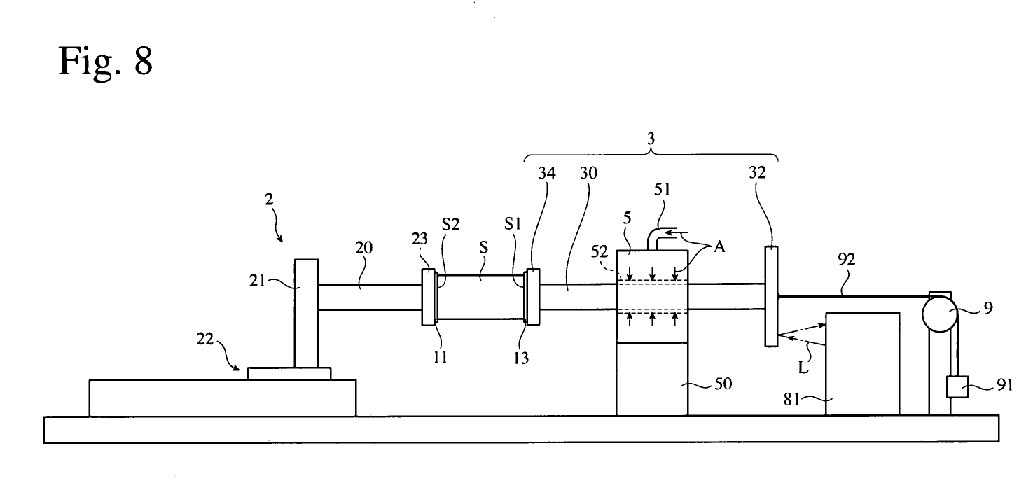

FIG. 8 shows a still further example of the displacement-measuring apparatus. The example shown in FIG. 8 is substantially the same as shown in FIG. 6, except that a columnar sample S is held by the fixing plate 23 and the movable plate 34. Accordingly, only differences will be explained below.

A work electrode 11 formed on the rear end S2 of the sample S is bonded to a fixing plate 23. A counter electrode 13 formed on the front end S1 of the sample S is fixed to a movable plate 34. The sample S is made of a solid electrolyte and in contact with the work electrode 11 and the counter electrode 13 at both ends S2, S1, so that electric current can be supplied.

With a weight 91 suspending from a pulley 9, voltage is applied such that the work electrode 11 acts as an anode or a cathode. When sufficient voltage is applied, the sample S contracts against a load of the weight 91, so that the movable rod 30 moves leftward in the figure. The reflection plate 32 fixed to the front end of the movable rod 30 also moves by the same distance, enabling the measurement of the displacement by a laser displacement sensor 81.

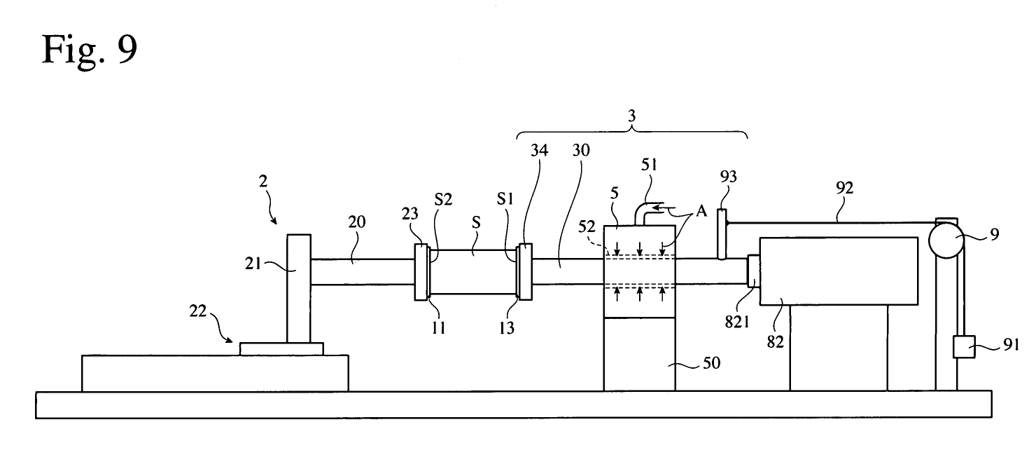

FIG. 9 shows a still further example of the power-measuring apparatus. The example shown in FIG. 9 is substantially the same as shown in FIG. 7, except that a columnar sample S is fixed between the fixing plate 23 and the movable plate 34. Accordingly, only differences will be explained below.

A work electrode 11 formed on a rear end S2 of a sample S is fixed to a fixing plate 23. A counter electrode 13 formed on a front end S1 of the sample S is bonded to a movable plate 34. The sample S is made of a solid electrolyte and in contact with the work electrode 11 and a counter electrode 13 at both ends S2, S1, so that electric current can be supplied.

When no electric current is supplied to the sample S, the movable rod 30 pushes a load button 821. When voltage is applied such that the work electrode 11 acts as an anode or a cathode, a contracting force is generated by the sample S to pull the movable rod 30 toward the sample S, resulting in decrease in a load applied to the load button 821. This decreased amount of load corresponds to the contracting power generated by the sample S.

The positions of fixing the string 92 and the sample S can be determined depending on the shape of the sample S and which is measured extension or contraction. Variations of the displacement-measuring apparatus of the present invention are shown in Table 1.

TABLE 1

| Shape of | Direction | Position of Fixing | Position of | |
|---|---|---|---|---|
| Sample S | of Load⁽¹⁾ | String 92 | Fixing Sample S | Figure |
| Powder | Pushing⁽²⁾ | Load-Applying | Cell 1 | |
| Compact | | Plate 31 | | |
| | Pushing | Reflection Plate 32 | Cell 1 | — |
| | Pushing | Load-Applying | Fixing Plate 23 | — |
| | | Plate 31 | | |
| | Pushing | Reflection Plate 32 | Fixing Plate 23 | — |
| | Pulling⁽³⁾ | Load-Applying | Cell 1 | — |
| | | Plate 31 | | |
| | Pulling | Reflection Plate 32 | Cell 1 | — |
| | Pulling | Load-Applying | Fixing Plate 23 | — |
| | | Plate 31 | | |
| | Pulling | Reflection Plate 32 | Fixing Plate 23 | — |
| Membrane | Pulling | Reflection Plate 32 | Cell 1 | — |
| | Pulling | Movable Plate 34 | Cell 1 | — |
| | Pulling | Reflection Plate 32 | Fixing Plate 23 | |
| | Pulling | Movable Plate 34 | Fixing Plate 23 | — |
| Column | Pushing | Reflection Plate 32 | Fixing Plate 23 | — |
| | Pushing | Movable Plate 34 | Fixing Plate 23 | — |
| | Pulling | Reflection Plate 32 | Fixing Plate 23 | |
| | Pulling | Movable Plate 34 | Fixing Plate 23 | — |

Note:
⁽¹⁾“Load” is a force applied from the weight 91 to the sample S.
⁽²⁾“Pushing” means that the sample S is compressed by the action of the weight 91, because the pulley 9 is placed on the rear side of the position of fixing the string 92 (left side in the figure).
⁽³⁾“Pulling” means that the sample S is pulled by the action of the weight 91, because the pulley 9 is placed on the front side of the string-fixing position (right side in the figure).

Variations of the power-measuring apparatus of the present invention are shown in Table 2.

TABLE 2

| Shape of | Direction | Position of Fixing | Position of | |
|---|---|---|---|---|
| Sample S | of Load⁽¹⁾ | String 92 | Fixing Sample S | Figure |
| Powder | Pushing⁽²⁾ | Load-Applying | Cell 1 | |
| Compact | | Plate 31 | | |
| | Pushing | Load-Applying | Fixing Plate 23 | — |
| | | Plate 31 | | |
| | Pulling⁽³⁾ | Load-Applying | Cell 1 | — |
| | | Plate 31 | | |
| | Pulling | Supporting Member | Cell 1 | — |
| | | 93 | | |
| | Pulling | Load-Applying | Fixing Plate 23 | — |
| | | Plate 31 | | |
| | Pulling | Supporting Member | Fixing Plate 23 | — |
| | | 93 | | |
| Membrane | Pulling | Supporting Member | Cell 1 | — |
| | | 93 | | |
| | Pulling | Movable Plate 34 | Cell 1 | — |
| | Pulling | Supporting Member | Fixing Plate 23 | |
| | | 93 | | |
| | Pulling | Movable Plate 34 | Fixing Plate 23 | — |
| Column | Pushing | Movable Plate 34 | Fixing Plate 23 | — |
| | Pushing | Supporting Member | Fixing Plate 23 | — |
| | | 93 | | |
| | Pulling | Movable Plate 34 | Fixing Plate 23 | — |
| | Pulling | Supporting Member | Fixing Plate 23 | |
| | | 93 | | |

Note:
⁽¹⁾“Load” is a force applied from the weight 91 to the sample S.
⁽²⁾“Pushing” means that the sample S is compressed by the action of the weight 91, because the pulley 9 is placed on the rear side of the position of fixing the string 92 (left side in the figure).
⁽³⁾“Pulling” means that the sample S is pulled by the action of the weight 91, because the pulley 9 is placed on the front side of the string-fixing position (right side in the figure).

The present invention will be explained in more detail referring to Examples below without intention of restricting the present invention thereto.

### EXAMPLE 1

3 g of iron trichloride, 1 g of copper chloride and 3.6 g of sodium p-toluene sulfonate were dissolved in 100 mL of water. While stirring the resultant solution at room temperature, 1 g of pyrrole was slowly dropped. After stirring for 2 hours after the completion of dropping, the resultant black precipitate was filtered out, and washed with ethanol and distilled water in this order to obtain polypyrrole powder. Voltage-resistance measurement revealed that the polypyrrole powder had resistance of 20 Ω.

The polypyrrole powder was charged into an IR tablet mold having a diameter of 10 mm, and compressed at a pressure of 748-873 MPa for 5 minutes while evacuating the tablet mold, to form a polypyrrole powder compact S. The powder compact had a thickness of 0.5 mm.

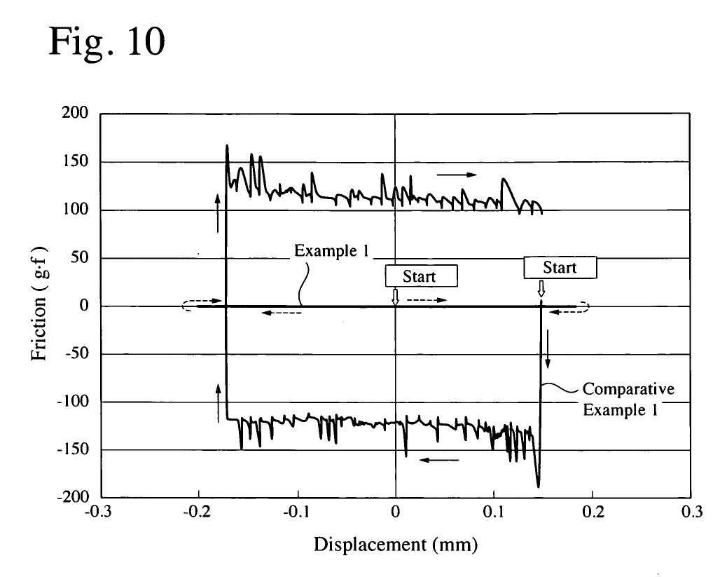

A platinum foil having a thickness of 30 μm was attached as a work electrode 11 to one surface of this polypyrrole powder compact S, and the work electrode 11 was connected to a lead wire. After putting the resultant assembly in a cell 1 of the displacement-measuring apparatus shown in FIGS. 3 and 4, voltage was applied while supplying air A to the air bearing 5. The displacement of the reflection plate 32 and friction at the air bearing 5 caused by the extension and contraction of the polypyrrole powder compact S were measured under the following conditions. The results are shown in FIG. 10.
Ion donor: Aqueous solution of NaPF₆ (1 mol/L),
Work electrode: Platinum foil,
Counter electrode: Platinum wire,
Reference electrode: Silver wire, and
Applied voltage: −0.3 V to +0.3 V.

### COMPARATIVE EXAMPLE 1

The displacement of the reflection plate 32 and the friction at the air bearing 5 were measured in the same manner as in Example 1, except that the supply of air A to the air bearing 5 was stopped after the displacement reached about 0.14 mm. The measurement results are shown in FIG. 10.

While little friction was generated at the air bearing 5 in Example 1, the friction of about −150 g·f to +150 g·f was generated in Comparative Example 1. The displacement was smaller in Comparative Example 1 than in Example 1. This appears to be due to the fact that the displacement of the movable member 3 was reduced by the friction in Comparative Example 1.

### EFFECT OF THE INVENTION

Because the displacement-measuring apparatus of the present invention comprises a movable member horizontally supported and attached to a front end of a sample, the movable member is moved by the extension and/or contraction of the sample, and its displacement can be detected by a displacement sensor. Because the movable member is supported by a reduced-friction bearing, the displacement is not or hardly attenuated by friction, enabling the precise measurement of the power.

Because the power-measuring apparatus of the present invention comprises a movable member attached to a front end of a sample and horizontally supported by a reduced-friction bearing, a front end of movable member being connected to a load cell, the pushing force and/or pulling force generated by the sample is transmitted to the load cell via the movable member and measured thereby. Because the movable member is supported by the reduced-friction bearing, the power can be transmitted to the load cell with substantially no loss, enabling the precise measurement of the power.

Further, because the displacement- or power-measuring apparatus of the present invention activates a sample horizontally, the observation of the sample is easy during measurement, and the exchange of samples can be conducted easily.

1-22. (canceled)

23. An displacement-measuring apparatus for measuring the extension and/or contraction of a sample as displacement, comprising a working means for extending or contracting a sample, a movable member connected to a front end of said sample, a reduced-friction bearing for supporting said movable member horizontally and movably, and a displacement sensor for detecting the displacement of said movable member, whereby said sample extends and/or contracts by the action of said working means to cause the displacement of said movable member, which is detected by said displacement sensor.

24. The displacement-measuring apparatus according to claim 23, wherein said displacement is measured by extending and/or contracting said sample while applying a load to said movable member in an opposite direction to the displacing direction of said movable member.

25. The displacement-measuring apparatus according to claim 23, further comprising a cell containing said sample, a pulley provided on the rear side of a front end of said movable member, and a weight suspending from said pulley with a string, the rear end of said sample being fixed in said cell, and said string being horizontally supported by said movable member and said pulley so that a load is applied from said weight to said sample when extending, and said working means acting to extend said sample, thereby displacing said movable member forward so that the extension of said sample is measured.

26. The displacement-measuring apparatus according to claim 23, further comprising a cell containing said sample, a pulley provided on the front side of a rear end of said movable member, and a weight suspending from said pulley with a string, the rear end of said sample being fixed in said cell, and said string being horizontally supported by said movable member and said pulley so that a load is applied from said weight to said sample when contracting, and said working means acting to contract said sample, thereby displacing said movable member rearward so that the contraction of said sample is measured.

27. The displacement-measuring apparatus according to claim 23, further comprising a sample-fixing rod, a stand horizontally supporting said fixing rod, a pulley provided on the rear side of a front end of said movable member, and a weight suspending from said pulley with a string, said string being horizontally supported by said movable member and said pulley so that a load is applied from said weight to said sample when extending, and said working means acting to extend said sample, thereby displacing said movable member forward so that the extension of said sample is measured.

28. The displacement-measuring apparatus according to claim 23, further comprising a sample-fixing rod, a stand horizontally supporting said fixing rod, a pulley provided on the front side of a rear end of said movable member, and a weight suspending from said pulley with a string, said string being horizontally supported by said movable member and said pulley so that a load is applied from said weight to said sample when contracting, and said working means acting to contract said sample, thereby displacing said movable member rearward so that the contraction of said sample is measured.

29. The displacement-measuring apparatus according to claim 23, wherein said reduced-friction bearing is an air bearing.

30. An apparatus for measuring power generated as a pushing force and/or a pulling force by the extension and/or contraction of a sample, comprising a means for activating said sample, a movable member connected to a front end of said sample, a load cell attached to a front end of said movable member, and a reduced-friction bearing horizontally and movably supporting said movable member, said power generated by said sample by the action of said working means being transmitted to said load cell via said movable member and measured thereby.

31. The power-measuring apparatus according to claim 30, wherein the pushing force and/or pulling force of said sample is measured with a load applied to said sample in an opposite direction to the moving direction of said movable member.

32. The power-measuring apparatus according to claim 30, further comprising a pulley provided on the rear side of a front end of said movable member, and a weight suspending from said pulley with a string, said string being horizontally supported by said movable member and said pulley so that a load is applied from said weight to said movable member when said pushing force is generated.

33. The power-measuring apparatus according to claim 30, further comprising a pulley provided on the front side of a rear end of said movable member, and a weight suspending from said pulley with a string, said string being horizontally supported by said movable member and said pulley so that a load is applied from said weight to said movable member when said pulling force is generated.

34. The power-measuring apparatus according to claim 30, further comprising a sample-fixing rod attached to a rear end of said sample, a stand horizontally supporting said fixing rod, a pulley provided on the rear side of a front end of said movable member, and a weight suspending from said pulley with a string, said string being horizontally supported by said movable member and said pulley so that a load is applied from said weight to said sample when said pushing force of said sample is generated.

35. The power-measuring apparatus according to claim 30, further comprising a sample-fixing rod attached to a rear end of said sample, a stand horizontally supporting said fixing rod, a pulley provided on the front side of a rear end of said movable member, and a weight suspending from said pulley with a string, said string being horizontally supported by said movable member and said pulley so that a load is applied from said weight to said sample when said pulling force of said sample is generated.

36. The power-measuring apparatus according to claim 30, wherein said reduced-friction bearing is an air bearing.
